(19) United States
(12) Patent Application Publication
(10) Pub. No.: US 2016/0115729 A1
(43) Pub. Date: Apr. 28, 2016

(54) OVERLAPPING FIRE REFLECTIVE INSULATING BLINDS

(71) Applicant: Andrew Laurence Gooden, Mt Gambier (AU)

(72) Inventor: Andrew Laurence Gooden, Mt Gambier (AU)

(21) Appl. No.: 14/524,191

(22) Filed: Oct. 27, 2014

(51) Int. Cl. E06B 5/16; B60J 1/20

(52) U.S. Cl. CPC E06B 5/16; B60J 1/2094

(57) ABSTRACT

A blind system for use in a vehicle with a windscreen and two or more doors with windows. At least one blind is adapted to be permanently supported at its upper edge above the window of one door and deploy over the door window and at least partially over the windscreen. Typically there is a first door blind attached above the first door window and adapted to deploy over the window and partially over the windscreen, a second door blind attached above the second door window and partially over the windscreen and a third blind supported above the windscreen and adapted to deploy at least partially over the windscreen and of a size and shape so that each of the first and second door blinds overlaps at least a portion of the third blind.

### FIELD OF THE INVENTION

This invention relates to a system to protect the crew of a vehicle, typically a truck, during a fire. This protection is especially relevant during a bushfire where the fire may overtake the vehicle (burnover).

### BACKGROUND

During a burnover the crew stays in the truck and deploys reflective insulating blinds (curtains) over the inside of the glass, and waits for the fire front to pass. The curtains are typically attached (not always) at the top edge, stowed rolled up or Z folded or similar, and are positioned to minimise encroachment to vision. Typically they are held in place by fabric hook-and-loop type fasteners commonly referred to as Velcro. This system of fire protection has been developed over many years and is well known in the art.

A problem that occurs is that adjacent curtains traditionally have often overlapped on and had their vertical edges fastened to a pillar when deployed. This often necessitated folding in the ends of the curtain prior to rolling up or folding for storage, and the resultant double layer of material increases the bulk of the stowed curtain at the ends, which could be in front of the driver for instance and can impede outward vision for the crew.

It is an object of the present invention to overcome at least some of the aforementioned problems or provide the public with a useful alternative.

### SUMMARY OF THE INVENTION

In a first form of the invention there is proposed a blind system for use in a vehicle having a windscreen and at least two doors with windows where at least one blind is adapted to be permanently supported at its upper edge above the window of one door and deploy over the door window and at least partially over the windscreen.

In a further form of the invention there is proposed a blind system including:
a first door blind attached above the first door window and adapted to deploy over the window and partially over the windscreen;
a second door blind attached above the second door window and partially over the windscreen;
a third blind supported above the windscreen and adapted to deploy at least partially over the windscreen and of a size and shape so that each of the first and second door blinds overlaps at least a portion of the third blind

A blind system wherein each of the three blinds is adapted to be folded or rolled up into a storage position.

A blind system wherein each of the blinds is manufactured from a fire reflective material.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1 shows the inside of a typical cabin with the blinds rolled down;

FIG. 2 shows the cabin with the front windscreen blind rolled up; and

FIG. 3 shows the side blinds folded and being rolled up.

### DRAWING LABELS

The drawings include items labeled as follows:
10 cabin
12 front windscreen blind
14 front windscreen
16 LHS window blind
18 LHS window
20 RHS window blind
22 RHS window
24 pillars
26 side extensions of blinds

### DETAILED DESCRIPTION OF THE INVENTION

The following detailed description of a preferred embodiment of the invention refers to the accompanying drawings. Wherever possible, the same reference numbers will be used throughout the drawings and the following description to refer to the same and like parts. As used herein, any usage of terms that suggest an absolute orientation (e.g. “top”, “bottom”, “front”, “back”, “horizontal”, etc.) are for illustrative convenience and refer to the orientation shown in a particular figure. However, such terms are not to be construed in a limiting sense as it is contemplated that various components may in practice be utilized in orientations that are the same as, or different than those, described or shown. Dimensions of certain parts shown in the drawings may have been modified and/or exaggerated for the purposes of clarity or illustration.

Turning now to the drawings in detail there is shown the inside of a typical truck cabin 10. A front windscreen blind 12 extends over the front windscreen 14. A LHS window blind 16 extends over the LHS window 18 and a RHS window blind 20 extends over RHS window 22.

Typically the window and the windscreen blinds are attached above the windows and overlap at the corner pillars 24. However as the front windscreen may not be a true rectangular shape, is wider at the bottom than the top, when it is rolled up the blind or curtain may be so wide that the ends of the roll have to be bent around the corner, or the ends have to be folded in prior to rolling up, and this double layer of material increases the diameter of the roll at the ends, which could be in front of the driver for instance and can impede outward vision for the crew.

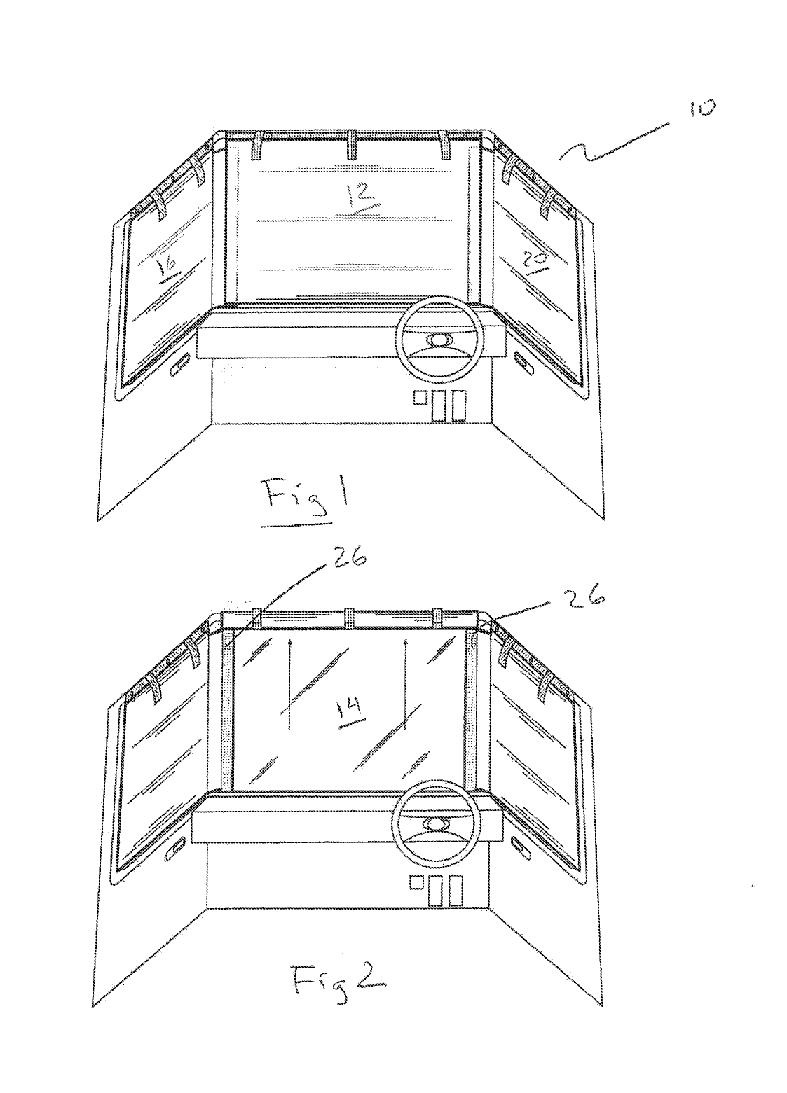

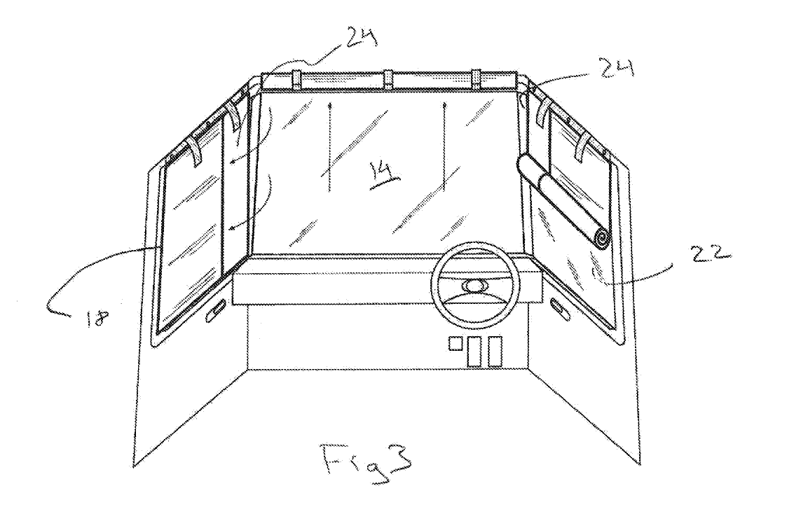

Thus as shown in FIG. 2 the window blinds include side extensions 26 over the windscreen 14. To roll them up the extensions 26 are folded back onto the blind (FIG. 3) and then they are rolled up for storage as illustrated in FIG. 4.

The present invention overcomes this problem by teaching that the blinds typically do not overlap on the pillars but rather on the glass, which means that it avoids the added bulk on the ‘vision critical’ curtain.

It is to be understood that whilst the present invention discussed the overlap from side windows to the windscreen it may equally well be applied to any area where the curtains would need to be folded before being rolled up regardless if they overlapped at the pillars or elsewhere.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the summary of the invention, except where the context requires otherwise due to express language or necessary implication, the word “comprising” is used in the sense of “including”, i.e. the features specified may be associated with further features in various embodiments of the invention.

1. A blind system for use in a vehicle having a windscreen and at least two doors with windows, said system comprising:
a first blind adapted to be permanently supported above the windscreen and to deploy over the windscreen;
a second blind adapted to be permanently supported at its upper edge above the window of one door and to deploy over the door window and at least partially cover the windscreen; and wherein the first and second blinds, when deployed, are attached to each other over the windscreen.

2. A blind system including:
a first door blind attached above a first door window of a vehicle and adapted to deploy over the first door window and partially over a windscreen of the vehicle;
a second door blind attached above a second door window and partially over the windscreen; and
a third blind supported above the windscreen and adapted to deploy at least partially over the windscreen and wherein the third blind is of a size and shape so that each of the first and second door blinds overlaps at least a portion of the third blind and is attached to the third blind over the windscreen.

3. The blind system as in claim 2 wherein each of the three blinds is adapted to be folded or rolled up into a storage position.

4. The blind system as in claim 3 wherein each of the blinds is manufactured from a fire reflective material.

5. The blind system as in claim 1, wherein the first blind has an upper edge, a lower edge and first and second side edges; and wherein the second blind has a lower edge opposite the first blinds upper edge, and first and second side edges; and wherein the partially overlapped portion of the first blind includes a region that extends from the upper edge of the first blind to the lower edge of the first blind.

6. The blind system as in claim 2, wherein the third blind has an upper edge and a lower edge; and wherein the overlapped portion of the third blind extends from the upper edge to the lower edge thereof.
